(19) United States
(12) Patent Application Publication
(10) Pub. No.: US 2020/0298482 A1
(43) Pub. Date: Sep. 24, 2020

(54) DETECTION OF BUILD MATERIAL IN A 3D PRINTING SYSTEM

(71) Applicant: HEWLETT-PACKARD DEVELOPMENT COMPANY, L.P., Houston, TX (US)

(72) Inventors: Adrien CHIRON, Sant Cugat del Valles (ES); Yngvar ROSSOW SETHNE, Sant Cugat del Valles (ES); Pablo DOMINGUEZ PASTOR, Sant Cugat del Valles (ES)

(73) Assignee: HEWLETT-PACKARD DEVELOPMENT COMPANY, L.P., Houston, TX (US)

(21) Appl. No.: 16/089,139

(22) PCT Filed: Oct. 17, 2016
(86) PCT No.: PCT/US2016/057292

§ 371 Date: Sep. 27, 2018

(51) Int. Cl. B29C 64/218; B29C 64/321

(52) U.S. Cl. CPC B29C 64/218; B33Y 30/00; B29C 64/321

(57) ABSTRACT

According to one example there is provided a build material supply system for a 3D printing system. The system comprises a feed tray for containing build material, a plate for removing build material from the feed tray and forming a pile of build material adjacent a spreader of the 3D printing system, and a sensor module to detect build material on the plate.

### BACKGROUND

In 3D (three-dimensional) printing, objects may be generated by forming successive layers of a build material on a build platform or support platform, and selectively solidifying portions of each layer of the build material.

Build material may be removed from a feed tray with a vane or plate, and a pile of build material may be placed adjacent a recoater or spreader. The spreader may spread the pile of build material to form a layer of build material on the support platform, over the previous layer that has been selectively solidified.

### BRIEF DESCRIPTION

Some non-limiting examples of the present disclosure will be described in the following with reference to the appended drawings, in which:

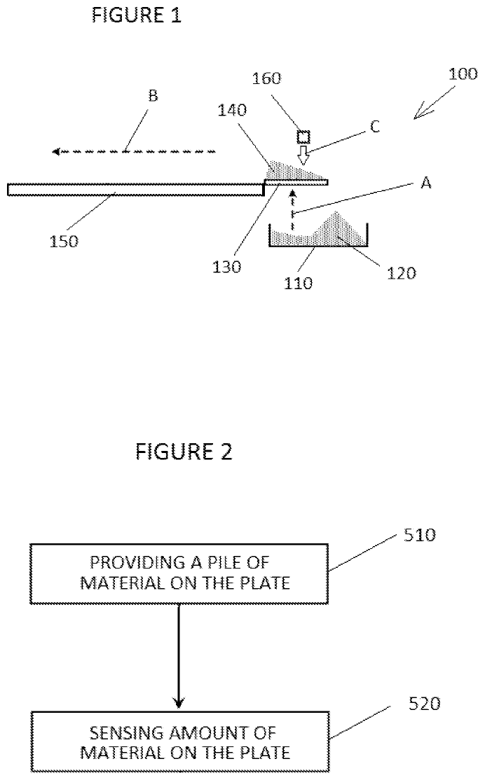

FIG. 1 is a simplified side view illustration of a build material supply system for a 3D printing system, according to one example;

FIG. 2 is a flow diagram outlining an example method for spreading build material in a 3D printing system, according to one example;

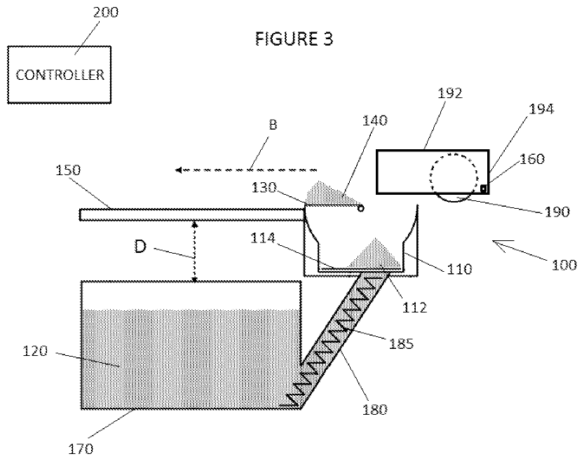

FIG. 3 is a simplified side view illustration of a 3D printing system according to one example;

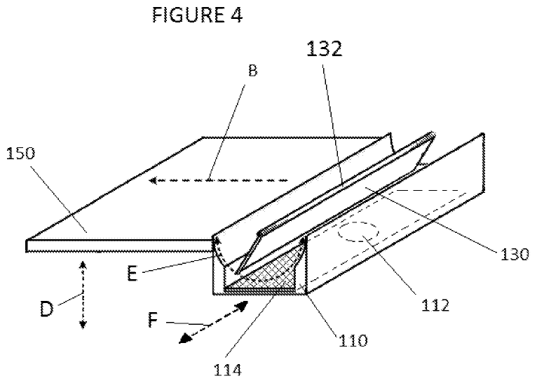

FIG. 4 is a simplified isometric illustration of a portion of a 3D printing system according to one example;

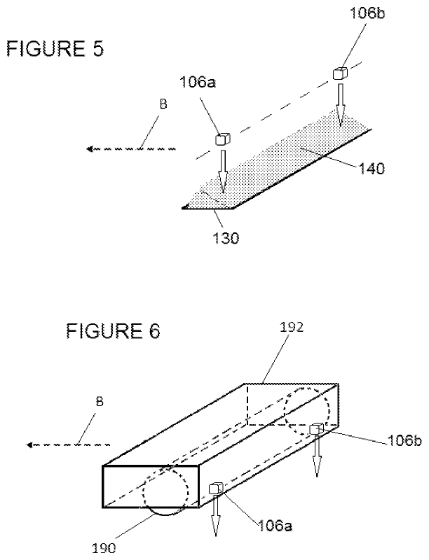

FIGS. 5 and 6 are simplified isometric illustrations of examples of the arrangement of sensors as disclosed herein;

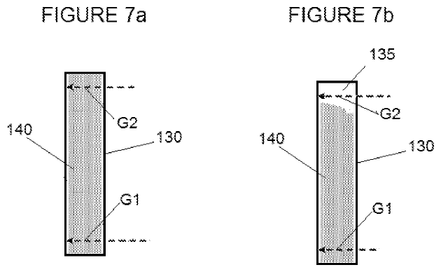

FIGS. 7a and 7b are simplified plan views of a plate of a build material supply systems, according to one example, in two different situations;

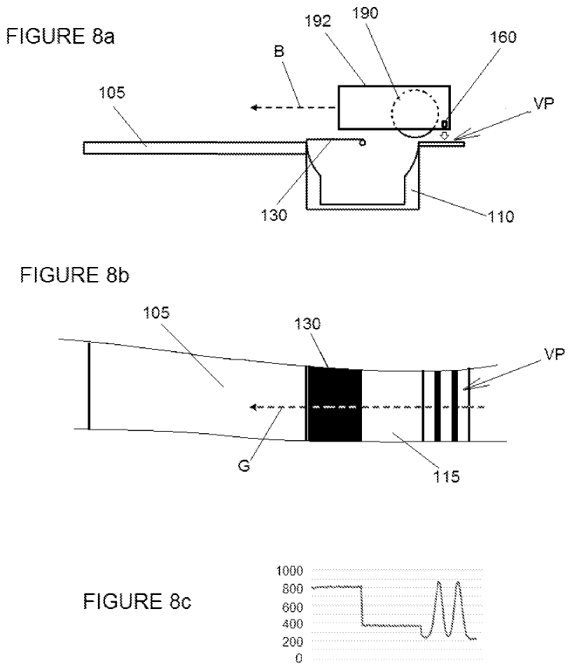

FIGS. 8a and 8b are respectively a simplified side view and a simplified, partial plan view of a 3D printing system according to one example;

FIG. 8c is a graph of the readings of a sensor in the example system of FIGS. 8a and 8b;

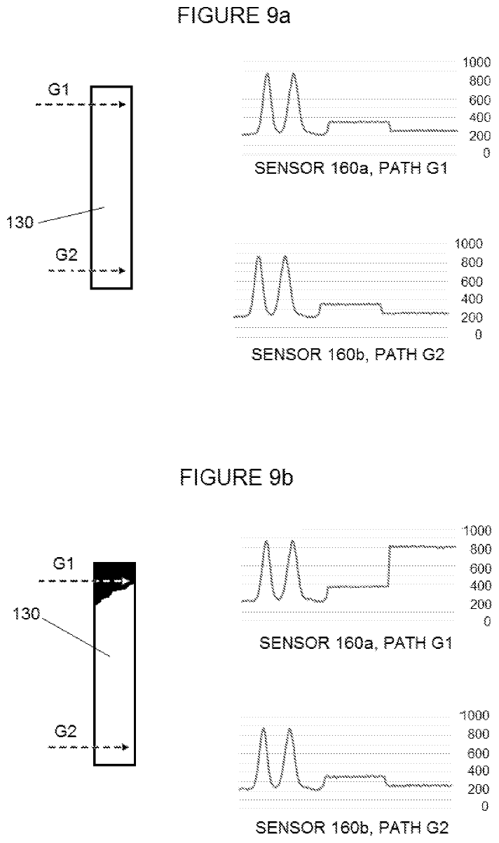

FIGS. 9a and 9b show simplified plan views of a plate of a build material supply system according to one example, in two different situations, and corresponding graphs showing sensor readings in each case;

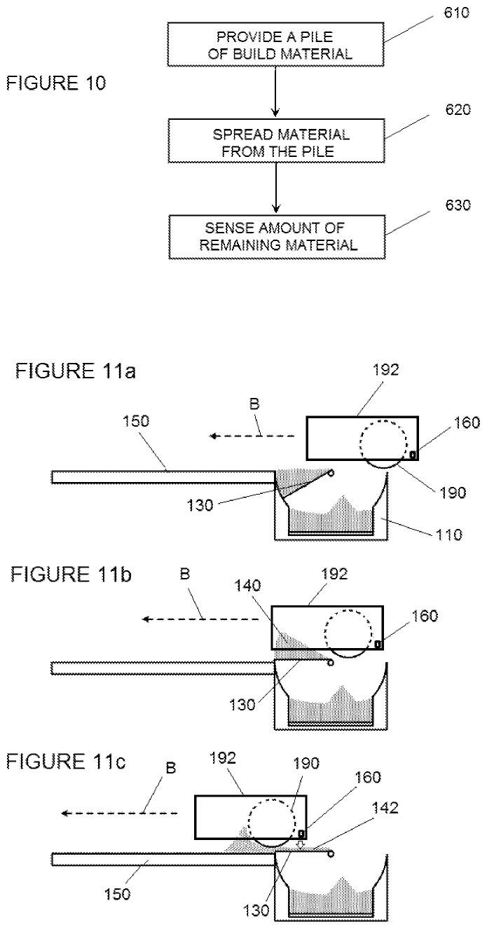

FIG. 10 is a flow diagram outlining a method for spreading build material in a 3D printing system, according to one example;

FIGS. 11a to 11c are schematic side views of a 3D printing system according to one example, illustrating an example method for spreading build material as disclosed herein;

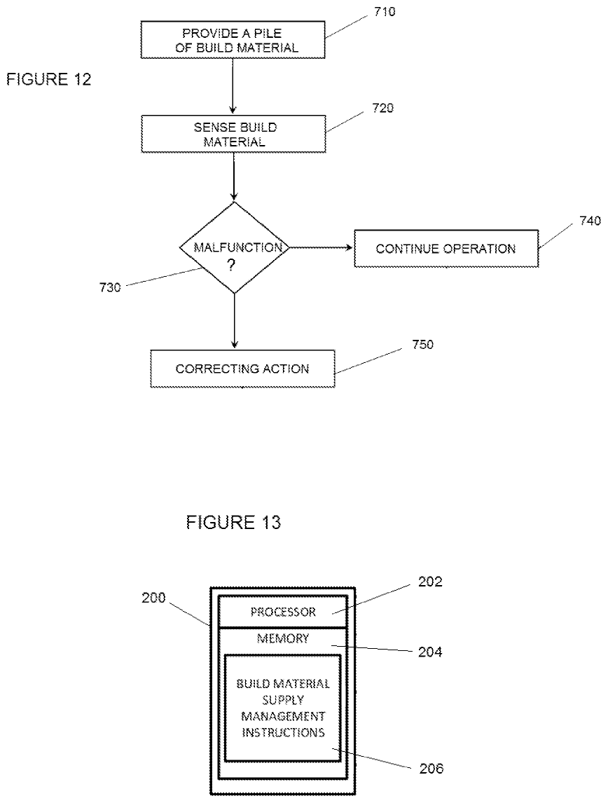

FIG. 12 is a flow diagram outlining another example method for spreading build material in a 3D printing system; and

FIG. 13 is a block diagram of a controller according to one example.

### DETAILED DESCRIPTION

Some 3D printing systems use build materials that have a powdered, or granular, form, such as for example powdered semi-crystalline thermoplastic materials. One suitable material may be Nylon 12, which is available, for example, from Sigma-Aldrich Co. LLC. Another suitable material may be PA 2200 which is available from Electro Optical Systems EOS GmbH.

In other examples other suitable build material may be used. Such materials may include, for example, powdered metal materials, powdered plastics materials, powdered composite materials, powdered ceramic materials, powdered glass materials, powdered resin material, powdered polymer materials, and the like.

During a 3D printing operation, an initial layer of build material is spread directly on the surface of a support platform, whereas subsequent layers of build material are formed on a previously formed layer of build material. Herein, reference to forming a layer of build material on the support platform may refer to, depending on the context, either forming a layer of build material directly on the surface of the support platform, or forming a layer of build material on a previously formed layer of build material.

Each layer of build material formed on the support platform is selectively solidified by any suitable build material solidification system, such as fusing agent deposition and heating systems, binder agent deposition systems, laser sintering systems, and the like, before forming the next layer.

FIG. 1 shows a portion of a build material supply system for a 3D printing system according to implementations disclosed herein. In FIG. 1 the build material supply system 100 may comprise a feed tray 110 for containing build material 120, a vane or plate 130 for removing build material from the feed tray 110 as shown by arrow A, and forming a pile 140 of build material adjacent a spreader or recoater (not shown in FIG. 1) of the 3D printing system.

The spreader or recoater may spread the pile 140 of build material in a spreading direction shown by arrow B, forming a layer of build material on a support platform 150 of the 3D printing system, as a first layer of build material or over previous layers which have been selectively solidified.

The build material supply system may also comprise a sensor module 160 to detect build material on the plate 130, as shown by arrow C.

With such a build material supply system, implementations of a method for spreading build material in a 3D printing system as disclosed herein may comprise, as illustrated in FIG. 2, at 510 providing a pile of build material on a plate adjacent a spreader of the 3D printing system, and at 520 sensing an amount of build material on the plate. Depending on the sensed amount of build material, different actions may be carried out, as will be explained later on.

Implementations of build material supply systems and spreading methods as disclosed herein may increase efficiency and reduce defects in the manufactured 3D objects, because a lack of build material, or an insufficient amount of build material, may be detected before spreading a layer, and the printing process may then be paused or stopped, and/or the build material feed process may be adjusted before further layers are formed.

FIG. 3 illustrates in side view a portion of a 3D printing system according to implementations disclosed herein, with a build material supply system. For clarity reasons not all the elements of the 3D printing system and the build material supply system are shown in FIG. 3. FIG. 4 is a simplified isometric view of part of the elements shown in FIG. 3.

The 3D printing system shown in FIGS. 3 and 4 may comprise a build material supply system 100. In some implementations the build supply system 100 comprises the feed tray 110, the plate 130 and the sensor module 160 to detect build material on the plate 130. The plate 130 may be rotatable around an axis 132, such as shown by arrow E in FIG. 4, but in other examples it may have a different operation. The sensor module 160 may be mounted in several configurations, for example as shown in FIG. 3 and disclosed later on. In some examples, the sensor module 160 may be to detect the presence or absence of build material on the plate 130, or it may be to detect the amount of build material on the plate 130.

In some implementations, the sensor module 160 may comprise an optical sensor. For example, the sensor module 160 may comprise a one-dimensional line sensor providing an output signal that is a function of the colour of the sensed surface.

A line sensor may comprise a light source and an electro-optical detector. The source illuminates the target surface, in this case the plate 130, and the detector produces an electrical signal related to the light reflected from the surface. In practice the source may be a light-emitting diode, or sometimes two or more such diodes emitting light of different colours. The light reflected, and therefore the electrical signal generated by the detector, depends e.g. on the colour of the target surface.

Thus, if the plate 130 and the build material are not of the same colour, the presence or absence of build material on the plate 130 may be determined from on the electrical signal produced by the line sensor. The amount and/or distribution of build material may also be determined to a certain extent, for example by sensing in several points of an area of the plate and taking into account the different sensor readings.

The plate 130 on which the build material is to be detected by the line sensor may be of a colour that contrasts with the colour of the build material: for example, the plate 130 may be of a dark colour, for example black, when the build material is of a light colour, for example white, thereby allowing reliable readings to be obtained from the line sensor.

The feed tray 110 forms a generally open container in which build material may be deposited and from which build material may be moved to enable it to be spread over the support platform 150. In FIG. 4, the foreground endplate of the feed tray 110 is not shown so as to allow the internal structure to be visible.

The feed tray 110 may have a length that, in some example, is substantially the same as the length of the support platform 150. In other examples, however, the feed tray 110 may be longer or shorter than the support platform 150.

The support platform 150 may be movable in the z-axis, as indicated by arrow D, to enable it to be lowered as each layer of build material formed thereon is processed by the 3D printing system.

In some implementations, build material 120 may be supplied to a delivery zone 112 of the feed tray 110 from a build material store 170, which may be located below the height of the feed tray 110, as shown in FIG. 3, for example through a feed channel 180. The feed channel 180 may comprise a feed mechanism, such as for example an auger screw 185. The delivery zone 112 may be positioned at any suitable position in the feed tray 110: for example, it may be in a central area along the length of the feed tray 110. In order to show such an example, in FIG. 4 the perimeter of the base of the feed tray 110 and the position of the delivery zone 112, which are not visible in the isometric view, have been schematically depicted in dotted lines.

In other examples build material may be delivered to the feed tray 110 using other suitable configurations such as, for example, from an overhead build material hopper.

In some implementations a build material distribution element 114 may be provided on the base portion of the feed tray 110, as shown in FIGS. 3 and 4, in order to distribute the build material throughout the feed tray 110, for example along all the length.

The build material distribution element 114 may comprise, in some examples, a mesh-like structure such as schematically represented in FIG. 4 for the portion that is visible from the end of the feed tray 110.

The build material distribution element 114 may be driven by any suitable drive system, such as a motor (not shown) and in some implementations it may be controlled to reciprocate by a small amount, for example up to about 1 cm, along the base of the feed tray 110 in the direction shown by arrow F, to help distribute the build material.

For example, in implementations such as shown in FIG. 4, the build material distribution element 114 may cause build material delivered to delivery zone 112 to move progressively along the feed tray 110 towards the two ends thereof, to provide build material along substantially all the length of the feed tray 110.

Thus, when the plate 130 removes build material from the feed tray 110, it may take up a suitable amount of build material along substantially all the length of the plate 130.

In FIG. 3, a pile 140 of build material that has been removed from feed tray 110 to be spread in a layer across the support platform 150 is shown on the plate 130, adjacent a horizontally movable build material spreader 190 according to implementations disclosed herein.

By the expression “adjacent the spreader” it is meant that the pile 140 of build material is in a position, also adjacent to the support platform 150, generally between the support platform 150 and the spreader 190 when the spreader is in the starting position for the spreading operation, at a level suitably close to level of the lower edge of the spreader 190, from where the build material of the pile 140 may be spread on the previously spread and selectively solidified layer of build material on the support platform 150.

In implementations of the build material supply system as disclosed herein the sensor module 160 may be displaceable along a scanning path over the plate 130.

The spreader 190 may be mounted on a suitable carriage or gantry 192, an example of which is depicted very schematically in FIG. 3. The spreader 190 may be a roller, although in other examples other suitable forms of spreader, such as a wiper blade, may be used.

In some implementations of a build material supply system and of a 3D printing system as disclosed herein, examples of which are shown in FIG. 3, the sensor module 160 to detect build material on the plate 130 may be mounted on the spreader carriage 192. However, the sensor module 160 may also be mounted stationary in the 3D printing system, for example in a position above the plate 130.

The example of FIG. 3 illustrates that when the sensor module 160 is mounted on the spreader carriage 192 it may be mounted between the spreader 190 and a trailing end 194 of the spreader carriage 192 in the spreading direction B, although in other examples the sensor module 160 may be mounted in other suitable positions on the spreader carriage 192.

When the sensor module 160 is mounted on the spreader carriage 192, such as in the example of FIG. 3, it is displaced together with the spreader 190 over the plate 130, such that in this example the scanning path is in the spreading direction of arrow B.

Some implementations of 3D printing systems as disclosed herein may comprise a sensor module with more than one sensor, for example two sensors, to detect build material on the plate 130, generally in different positions of the plate 130. For example, two sensors may be provided in correspondence with two different positions along the plate 130 to detect in each position the presence or absence of build material, or the amount of build material.

In some implementations, such as depicted in the examples of FIGS. 5 and 6, two sensors 160a and 160b to detect build material 140 may be provided in two corresponding positions of the plate 130 that are spaced apart at least 50% of the length of the plate. The length of the plate 130 is defined in the longitudinal direction of the plate 130 and of the spreader 190. The sensors may be fixed, as schematically shown in FIG. 5, or they may be displaceable, such as for example mounted on the spreader carriage 192, as described above and shown in FIG. 6.

In some examples, the two sensors 160a and 160b are provided near the ends of the plate, e.g. each at a distance of less than 100 mm from one of the ends of the plate. Providing the sensors near the two ends of the plate 130 allows detecting for example if the build material is being suitably distributed along all the length of the feed tray 110, for example between the delivery zone 112 (FIG. 4) and the two opposite ends of the feed tray 110.

In some implementations with two or more sensors 160, a distribution of the build material on the plate 130 may be detected. For example it may be detected if there is a substantially higher amount of build material at one end of the plate 130 than at the other end.

In some implementations of a build material supply system as disclosed herein, the sensor module 160, with one sensor or with several sensors if more than one sensor is provided, may be displaceable along a scanning path. In some examples, as disclosed above, the sensor or sensors may be mounted on the spreader carriage 192.

A scanning path along which the sensors are displaceable may comprise in some implementations a transverse line on the plate 130, such that build material may be detected at several points across the plate 130.

FIGS. 7a and 7b schematically show a plate 130 in plan view. On the plate 130 an arrow G1 represents one scanning path and an arrow G2 represents another scanning path, respectively for two sensors of a sensor module, such as, for example, the sensors 160a and 160b shown in FIG. 6.

FIG. 7a represents a situation in which the build material 140 covers substantially all the plate 130: the two sensors 160a and 160b will give similar signals, relatively constant along the scanning path G1 and G2.

FIG. 7b represents a situation in which not all the plate is covered with build material 140, for example due to a malfunctioning in the build material supply system. A malfunctioning may occur, for example, in the build material distributor element 114 (FIGS. 3 and 4), and may cause the level of build material at one end of the feed tray 110 to be too low, such that the plate 130 does not take build material from the feed tray 110 at this end thereof, or does not take enough build material.

In the case of FIG. 7b, the signal outputted by the sensor 160a when it is displaced along scanning path G1 will be similar to that provided in the case of FIG. 7a, but the signal outputted by the sensor 160b when it is displaced along scanning path G2 will be different from the case of FIG. 7b, because the scanning path G2 is not covered with build material 140, so the colour detected by the sensor 160b is not the same as in the case of FIG. 7a.

A case where one of the scanning paths G1 or G2 is partly covered with build material is also detectable, because the signal provided by the corresponding sensor will change during the displacement along the scanning path.

For practical reasons, in FIGS. 7a and 7b the portion of the plate 130 covered with build material 140 has been depicted in a dark colour, while the plate 130 itself has been left white: however, the build material 140 may be white or another clear colour, and the plate 130 may be black or another dark colour.

In some implementations, the build material supply system may comprise a sensor verification pattern, in order to check the correct operation of the sensor or sensors in the sensor module 160. For example, a sensor verification pattern may be provided in the sensor scanning path, and may comprise a number of graphic marks of a predetermined colour set to be detected by the sensor.

In implementations such as the example of FIGS. 3 and 4, a sensor verification pattern may be placed at the beginning of the travel of the spreader 190, as schematically shown in FIG. 8a, for example upstream of the feed tray 110.

For example, as shown in FIG. 8b, which is a partial plan view of the arrangement of FIG. 8a, a verification pattern VP may comprise two black lines.

Arrow G in FIG. 8b indicates the scanning path of a sensor of sensor module 160 of FIG. 8a: from right to left, in its displacement along the scanning path G the sensor first scans the verification pattern VP, then an intermediate zone 115 corresponding to the exposed part of the feed tray 110, and then the plate 130, which in this case is black or similarly dark coloured.

FIG. 8c is a diagram representing an example of the output signal of a sensor of sensor module 160 for the arrangement of FIGS. 8a and 8b, in an implementation in which the sensor is a line sensor, when there is no build material on plate 130: as shown in the diagram, the output signal is higher when the detected colour is darker. From right to left, the output signal has two peaks corresponding to the two black lines of the verification pattern VP, then a flat zone of low value when the sensor scans the intermediate zone 115 of the feed tray, and then a flat zone of high value when the sensor scans over the dark plate 130.

FIGS. 9a and 9b show by way of example the output signals in an implementation of a build material supply system with a sensor module comprising two sensors, such as for example as disclosed in FIGS. 6 and 7a, 7b, and with a verification pattern such as described above, in both scanning paths G1 and G2.

FIG. 9a represents a situation in which there is white build material along substantially all the length of the black plate 130, while FIG. 9b represents a situation in which one end of the black plate 130 is devoid of white build material. In the case of FIG. 9b the output signal of one sensor is different from that of the other sensor, showing that sensor 160 b is detecting the presence of build material on the plate 130, while 160a is not detecting the presence of build material on the plate 130.

The numerical value of the output signal is representative of the detected colour, on a scale given by the sensor itself that may be unrelated to specific physical parameters and is useful for reference and comparison purposes.

Implementations of methods for spreading build material in a 3D printing system will now be described by way of example.

As described earlier, implementations of the methods may comprise providing a pile of build material on a plate between the spreader and the support platform, and sensing build material on the plate. As disclosed above by way of example and in relation to FIGS. 3 and 4 and FIGS. 6 to 9, the sensing of build material on the plate may comprise displacing over the plate an optical sensor, such as a line sensor, in the spreading direction, to scan the plate along a scanning path.

In FIG. 10, an implementation of a method for spreading build material comprises at 610 providing a pile of build material on a plate, such as plate 130, adjacent a spreader of the 3D printing system, at 620 spreading build material from the pile of build material, and at 630 sensing an amount of build material remaining on the plate 130.

The sensing of the build material remaining on the plate 130 may be done at any time after the spreader 190 has left the plate 130 and is spreading build material on the support platform 150, for example just after the spreader 190, in its movement, has left the plate 130.

FIGS. 11a to 11c illustrate an implementation of such a method, which may be carried out for example with a system as disclosed in FIGS. 3 and 4.

In FIG. 11a, the spreader 190 mounted on its spreader carriage 192 is in a starting position, and the vane or plate 130 is holding a measured amount of build material to be placed adjacent the spreader 190 and to be spread forming a layer over the support platform 150.

In FIG. 11b, the spreader 190 has traveled in the spreading direction B to a position in which a forward part of the spreader carriage 192 covers the plate 130, and the plate 130 has raised to place a pile of build material 140 adjacent the spreader 190; the spreader 190 itself has not yet reached the build material.

In FIG. 11c the spreader 190 has advanced further in the spreading direction B, has passed over the plate 130, entraining build material from the pile, and is now spreading the entrained build material on the support platform 150. The sensor module 160 mounted on the spreader carriage 192, between the spreader 190 and the trailing edge of the carriage, is now scanning the plate 130 and sensing the build material 142 remaining on the plate 130. Different actions may be performed depending on the result of the sensing of build material remaining on the plate, as described below.

FIG. 12 is a flow diagram of implementations of a method for spreading build material comprising providing at 710 a pile of build material on a plate between the spreader and the support platform, sensing at 720 the build material on the plate, and at 730 determining if there is a malfunction of the 3D printing system, depending on the amount of build material sensed on the plate.

If no malfunction is determined at 730, the operation continues at 740 as it was programmed in the 3D printing system.

If a malfunction is determined, at 750 the system may perform at least one correcting action, for example an action selected from: issuing an alarm, issuing a diagnose of the system, pausing operation, providing another pile of build material on the plate, and/or increasing the amount of build material provided on the plate in a subsequent spreading operation.

If a malfunction is determined, and depending on the severity of the defect and on variables such as the printing quality, different actions may be performed.

In a 3D printing system with a build material supply system such as that disclosed in FIGS. 3 and 4, with a build material distribution element 114 in the feed tray 110, if one of the ends of the plate receives no build material or too little build material, it is likely that the problem is a malfunction of the build material distribution element 114. The solution to the problem may be to pause or stop the printing operation and perform a maintenance operation on the build material supply system.

However, it is also possible to temporarily or permanently increase the supply of build material to the feed tray prior to each layer being formed, such that even if the build material distribution element 114 is not functioning in the optimum manner and provides more build material towards one end of the feed tray than towards the other end, with an increased supply of build material the level is sufficient in all the length of the feed tray to form a suitable pile of build material all along the plate, and therefore defects in the printed object may be avoided.

In some cases it may be possible to solve the problem in the current or in successive layers, and continue the printing operation; in other cases it may be more convenient to pause or stop the printing operation without waiting for the object to be finished, so as to prevent the manufacture of an object with defects, and therefore saving time and materials.

In some implementations of a method such as shown in FIG. 12, the determination at 730 that there is a malfunction may depend on whether the amount of build material sensed on the plate, represented by the value of the sensor signal, is below a predetermined threshold.

For example, a malfunction may be determined if the sensor signal falls below 25% of a maximum value corresponding to the situation in which the plate is fully covered with build material. The maximum value depends on the colour of the build material, and may be determined by a simple calibration of the sensors of the sensor module for each build material.

In other implementations of a method such as shown in FIG. 12, the determination at 730 that there is a malfunction may depend on sensing the amounts of build material in two positions of the plate, determining the difference between the amount of build material sensed in one position and the amount of build material sensed in the other position, represented by the values of the corresponding sensor signals, and determining that there is a malfunction of the 3D printing system if the difference is above a predetermined threshold.

The determination may be made for each spread cycle, but it may also be made over a number of spread cycles or layers. For example, a malfunction may be determined if the difference between the readings of the sensors is more than 75% over more than 3 spread cycles.

For example, in a system with two sensors such as disclosed above, it may be determined that there is a malfunction if at least one of the sensors detects no build material on the plate, or an amount of build material that is below a predetermined threshold. It may also determined that there is a malfunction if the difference in the amount of build material detected by the two sensors is above a predetermined threshold, that is, if the difference between the readings of the sensors is above a predetermined threshold.

Operation of the 3D printing system and build material supply system 100 may be controlled by a controller, such as controller 200 in FIG. 3. As shown in greater detail in FIG. 13, the controller 200 may comprise a processor 202 coupled to a memory 204. The memory 204 stores management instructions 206 for the supply and spreading of build material that, when executed by the processor 202, control the operation of the systems and the methods disclosed herein.

Although a number of particular implementations and examples have been disclosed herein, further variants and modifications of the disclosed devices and methods are possible. For example, not all the features disclosed herein are included in all the implementations, and implementations comprising other combinations of the features described are also possible.

1. A build material supply system for a 3D printing system, comprising:
a feed tray for containing build material,
a plate for removing build material from the feed tray and forming a pile of build material adjacent a spreader of the 3D printing system, and
a sensor module to detect build material on the plate.

2. A system as claimed in claim 1, wherein the sensor module is to detect build material in two positions of the plate that are spaced apart at least 50% of the length of the plate, in the longitudinal direction of the spreader of the 3D printing system.

3. A system as claimed in claim 2, wherein each position is at a distance of less than 100 mm from one end of the plate, in the longitudinal direction of the spreader of the 3D printing system.

4. A system as claimed in claim 1, wherein the sensor module comprises an optical sensor.

5. A system as claimed in claim 4, wherein the sensor module comprises a line sensor providing an output signal that is a function of the colour of the sensed surface.

6. A system as claimed in claim 1, wherein a sensor of the sensor module is displaceable along a scanning path.

7. A system as claimed in claim 6, comprising a sensor verification pattern provided in the scanning path.

8. A 3D printing system, comprising:
a support platform,
a spreader for spreading successive layers of build material on the support platform,
a plate for supporting a pile of build material adjacent to the spreader, and
a sensors module to detect a distribution of build material on the plate.

9. A system as claimed in claim 8, wherein the spreader is mounted on a spreader carriage and the sensor module is mounted on the spreader carriage between the spreader and a trailing end of the carriage in the spreading direction.

10. A method for spreading build material in a 3D printing system, comprising:
providing a pile of build material on a plate adjacent a spreader of the 3D printing system, and
sensing an amount of build material on the plate.

11. A method as claimed in claim 10, comprising spreading build material from the pile of build material, and sensing an amount of build material remaining on the plate.

12. A method as claimed in claim 10, comprising displacing an optical sensor over the plate in the spreading direction.

13. A method as claimed in claim 10, comprising
determining if there is a malfunction of the 3D printing system depending on the amount of build material sensed on the plate, and
in case a malfunction is determined, perform at least one action selected from:
issuing an alarm, issuing a diagnose of the system, pausing operation,
providing another pile of build material on the plate, increasing the amount of build material provided on the plate in a subsequent spreading operation.

14. A method as claimed in claim 13, comprising determining that there is a malfunction of the 3D printing system if an amount of build material sensed on the plate is below a predetermined threshold.

15. A method as claimed in claim 13, comprising sensing the amounts of build material in two positions of the plate, determining the difference between the amount of build material sensed in one position and the amount of build material sensed in the other position, and determining that there is a malfunction of the 3D printing system if the difference is above a predetermined threshold.
